(19) United States
(12) Patent Application Publication
(10) Pub. No.: US 2011/0282534 A1
(43) Pub. Date: Nov. 17, 2011

(54) Method and Device for Managing the Power From A Power Train of A Hybrid Motor Vehicle

(75) Inventors: Nawal Jaljal, Nanterre (FR); Fabien Mercier-Calvairac, Paris (FR); Vincent Mulot, Paris (FR); Patrick Lagonotte, Futuroscope Chasseneuil Cedex (FR)

(73) Assignee: PEUGEOT CITROEN AUTOMOBILES SA, Velizy Villacoublay (FR)

(21) Appl. No.: 13/146,774

(22) PCT Filed: Dec. 24, 2009
(86) PCT No.: PCT/FR2009/052696

§ 371 Date: Jul. 28, 2011

(30) Foreign Application Priority Data
Jan. 29, 2009 (FR) 0950563

(51) Int. Cl. B60W 20/00; B60K 11/00

(52) U.S. Cl. 701/22; 180/65.265; 903/930

(57) ABSTRACT

The invention relates to a method and a device for managing the power from a power train of a hybrid motor vehicle, taking into account one or more operational parameters of at least one element of said power train. The method is characterised in that the determination of the consumption gain (6) is based on one or more operational parameters of at least one or part of said elements (1 to 5) in the power train. Advantageously, said operational parameter is the respective temperature of at least one or part of the elements (1 to 5) in the power train. The invention is suitable for use in the field of motor vehicles.

### CROSS-REFERENCE TO RELATED APPLICATIONS

The application is the US National Stage of International App. No. PCT/FR2009/052696 filed Dec. 24, 2009, and which claims priority to French App. No. 0950563 filed Jan. 29, 2009.

### TECHNICAL AREA

This method and device for managing the energy of a power train of a hybrid vehicle by taking into account one or more parameters of at least one element present in the power train improves the electrical performance of the power train, while minimizing fuel consumption and preserving the life span of the power train's energy storage system during actual use.

### BACKGROUND

FIG. 1 schematically illustrates a typical hybrid power train.

As is known, a hybrid power train comprises an internal combustion engine 1 which supplies mechanical energy to the drive wheels 2 of a vehicle (only one wheel 2 is shown in the figure), and one or more electrical machines 3 (two machines are shown in FIG. 1). At least one of the machines 3 can function as electric motor to supply electrical energy to the wheels 2 of the vehicle. The power train also comprises an electrical power or energy storage means 4 connected to the electrical machines 3 by dotted lines in the figure, and a transmission means 5 for transmitting the mechanical and electrical energy to the wheels 2 of the vehicle.

The transmission means 5 comprises for instance mechanical linkage elements such as gears, clutches, planetary gear trains, etc.

In addition, this kind of power train comprises in general a means for recuperating electrical energy. The energy recuperating means can be incorporated in at least one of the two electrical machines 3. The energy recuperation means can comprise, for instance, an electrical machine functioning as current generator during deceleration. The machine can function as a generator to transform the mechanical and/or kinetic energy it receives from the wheels to electrical energy.

It is known, specifically from PCT Publication No. WO-A-2008/053107, that the traction of a hybrid vehicle with the above described power train can be regulated by selecting either thermal or electrical traction mode as a function of the fuel consumption gain calculated in real time, starting from a fuel consumption which corresponds with a characteristic of combustion engines known as marginal consumption.

For the calculation of the fuel consumption gain of this power train, it is therefore particularly pertinent for these short driving distances to take into account the thermal state of at least one of the various elements of the power train of a vehicle.

### BRIEF SUMMARY

To this end, the goal of the invention is a method for managing the energy of a power train of a hybrid vehicle comprising a combustion engine and at least one electrical machine that can serve as an electric motor. This method comprises a stage where the fuel consumption gain of the combustion engine is determined in real time by the taking the difference between the thermal mode consumption and the estimated electrical mode consumption, characterized in that the consumption gain is determined as a function of one or more operational parameters of one or more of the elements of the power train.

Conso: the fuel consumption of the combustion engine
when the elements of the power train includes means for recuperating energy and means for storing energy, the method comprises a stage where the combustion engine is turned off or on as a function of one or more criteria and as a function of fuel consumption gain G; and where a positive fuel consumption gain is a necessary but not sufficient condition for turning off the combustion engine,

### BRIEF DESCRIPTION OF THE SEVERAL VIEWS OF THE DRAWINGS

FIG. 1 is a schematic representation of a power train of a hybrid automotive vehicle showing various elements of the power train, this power train is known in the current state of technology,

### DETAILED DESCRIPTION

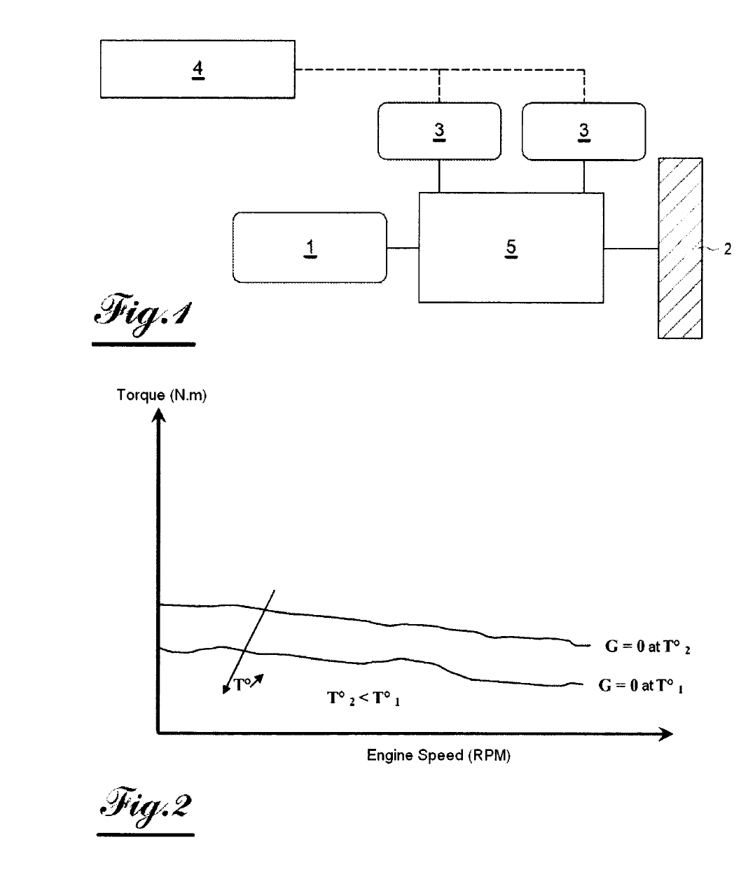

FIG. 1 was described above and will not be described further.

In the following description, the various elements of the power train of the hybrid vehicle will be referenced relative to FIG. 1.

In addition, the operational parameter used for managing the energy in the power train of the vehicle described hereafter will be a thermal state of one or more of the elements of the power train. It should be kept in mind that temperature is an advantageous parameter for controlling the energy management in the power train, but not the only parameter to be taken into account and/or that the temperature can also be associated to one or more supplementary operational parameters of this element or some of the elements of the power train.

The present invention relates to a method for managing the energy in a power train of a hybrid vehicle comprising a combustion engine 1 and at least one electrical machine 3 that can serve as an electric motor.

This method comprises a stage where the fuel consumption gain G of the combustion engine 1 is determined in real time by taking the difference between thermal mode fuel consumption and electrical mode fuel consumption. This gain G is shown in the curves of FIG. 2 as having a zero value.

where Conso is the fuel consumption of the combustion engine during its operation,

and COnso_{equivalent} is the estimated consumption that the electric motor will have at the same operating conditions.

According to the disclosed energy management method, the fuel consumption gain G is determined as a function of one or more operational parameters of one or more of the elements 1-5, illustrated in FIG. 1, of the power train.

Advantageously, when the power train comprises energy recuperation means and energy storage means 4, the method comprises a stage where the combustion engine 1 is turned off or on as a function of one or more criteria and as a function of the fuel consumption gain G; and where a positive fuel consumption gain is a necessary but not sufficient condition for turning off the combustion engine.

Advantageously, the respective temperature of one or more of the elements 1-5 of the power train is the is the most pertinent parameter of the operating conditions to be taken into account, in particular during the transitory operating phases of the engine, for instance immediately after the start of the engine.

The temperature can also be taken in combination with at least one other operational parameter for determining the equivalent consumption, Conso_{equivalent}.

Advantageously, after determining the consumption gain G, given by the difference between the consumption, Conso, of the running combustion engine and the equivalent consumption, Conso_{equivalent}, by extrapolating a stop of the combustion engine therefore with electrical power train, a decision is made to stop the combustion engine 1 if the fuel consumption gain G is positive and the power train becomes electric.

However, as previously mentioned, this can also be done or not relative to one criterion or several criteria. For instance this criterion can depend on the recuperation level of the electrical energy recuperation means and/or the temperature of at least one of the elements 1-5 of the power train.

In a first implementation mode of the method, this criterion, in combination or not with other operational criteria, which depends on the characteristic temperature of the combustion engine 1 prevents the combustion engine 1 from being turned off as long as the characteristic temperature has not reached a predetermined value.

In a second implementation mode of the method, this criterion, in combination or not with other criteria, is determined in such a manner as to increase the utilization of the electrical energy storage means 4 while turning off, as often as possible, the combustion engine 1. This provides a compromise between fuel economy by turning off combustion engine 1 and recharging of the electrical energy recuperation means which may require running of combustion engine 1.

The equivalent consumption, Conso_{equivalent}, with combustion engine 1 turned off, in other words with electrical power train, is estimated in the following manner.

During pure electric traction, the real fuel consumption, Conso, of the combustion engine 1 is zero, but the electrical energy storage system 4, for instance in the form of one or more batteries as a power source of the electric motor, will discharge. The discharge is equal to the necessary power at wheel 2 to ensure traction, except for transmission losses.

By replacing the equivalent consumption Conso_{equivalent} in the previously mentioned equation, the fuel consumption gain G can be derived as follows:

G(g/s)=Conso−Conso_{equivalent}

G(g/s)=Conso−K[Pmth/η_{elec}]

wherein, in the last equation:
Conso is the fuel consumption of the combustion engine 1,
Pmth is the power supplied by the combustion engine,
K is a proportionality coefficient defined by a predetermined chart of the combustion engine,
η_{elec} is the efficiency of the electrical machine. The efficiency is a function of one or more operational parameters of the power train, by preference the temperature respectively of one or more of the elements 1-5 of the power train.

The equation for gain G, which advantageously determines how the stops and starts of the combustion engine are managed, brings forward physical parameters which depend on the operational parameters of the power train and in particular of the respective temperature of one or more of the elements 1-5 of the power train.

The evolution of this operational parameter, or these operational parameters, specifically the temperature, for instance during transitory thermal stages after starting the combustion engine 1, is taken into account according to the data measured by sensors installed in the different elements of the hybrid power train. These sensors are suitable for measuring the value of this operational parameter, or these operational parameters, for instance the temperature.

A management device is provided for implementing the method. The management device comprises a control unit, having for instance processors, for calculating the consumptions Conso and Conso_{equivalent}, as well as sensors for at least one operational parameter of the power train. These sensors are positioned on one or more of the elements of the power train where the operational parameter, or one of the operational parameters, is used for managing the energy in this power train by means of the consumption calculations.

In the case when the temperature is the operational parameter, or one of the operational parameters, used for calculating the fuel consumption gain G, FIG. 2 provides a schematic representation of the engine torque curves as a function of the engine speed for different operating temperatures of the engine and for a given value of the fuel consumption gain. The operating temperature may be the characteristic temperature of the combustion engine 1 or correlated to it, and if necessary corrected in relation with it.

The calculation of cold fuel consumption is based on the increase of the supplementary friction torque during transitory thermal phases. The increase of cold fuel consumption corresponds then to a translation of the hot fuel consumption curve towards higher torques, as illustrated in FIG. 2 where the engine torque increases when the operating temperature of the engine decreases, this for zero value of gain G and for the same engine speed.

Once started, the overconsumption due to the supplementary torque required from the engine in order to recharge the energy storage means 4 is directly related to the torque increase.

The coefficient K, mentioned in the preceding equation, does not depend on temperature. This coefficient is relatively constant relative to engine speed and engine torque, conferring precision and simplicity to the strategy on which the disclosed method is based as compared to other strategies that take into account the overall average efficiency of the engine, since the efficiency varies significantly as a function of engine speed and torque.

Transmission losses represent the second factor of overconsumption during transitory thermal phases. They are represented in the two previously mentioned consumptions of the equation for gain G, Conso and Conso_{equivalent}, in particular in the value of the consumption, Conso, when the combustion engine 1 is running.

In accordance with the method, it is therefore not necessary to use the characteristic temperature of transmissions as a parameter for calculating these losses.

On the other hand, according to the method it is advantageous to use the temperature parameter for calculating charging and discharging losses, since the electrical energy storage means 4 of the power train and/or of the electrical machine 3 serve as an electrical generator for the power train of the vehicle.

It is evident that the range of the gain G in fuel consumption offered by energy optimization cannot exceed the limit of the direct impact of the temperature of the elements on the fuel consumption of the vehicle, since the consumption is of primary importance for the calculation of the gain, contrary to other operating parameters of the power train.

The recharging strategy for energy storage means 4 involves selecting the power of the combustion engine 1 when it is turned on. Taking into account the thermal state of one or more of the elements 1-5 of the power train in the calculation of the consumption gain G results in a significant increase of traction in electric mode, in the order of 10% in MVEG cycle. The MVEG cycle is an officially recognized cycle used in Europe for fuel consumption and emission of combustion gas. This cycle comprises city driving and highway driving at average speeds of 18.8 and 62.6 km/h (11.7 and 38.9 mph, respectively). The MVEG cycle is performed with a cold engine start at a temperature of 20° C.

In order to favor at the same time the rise in temperature of the combustion engine 1 to lower the consumption, it is preferable to use thermal management, if necessary in parallel with minimization of the recharging losses.

In the context of a cold vehicle start, as soon as a request coming from the driver or from the charge level of the energy storage means 4 necessitates starting of the combustion engine 1, the shutdown of the combustion engine can be prevented as long as the characteristic temperature has not reached a predetermined threshold.

Since the basic algorithm for the elaboration of this method is simple, compared to strategies currently used in prototypes of hybrid vehicles, the power of the processors included in the control module of the management device is reduced when the described method is implemented.

By taking into account the transitory thermal phases, the described method results in an increase of the electrical driving performance and this at zero cost.

1. A method for managing the energy of a power train of a hybrid vehicle comprising several elements including a combustion engine and at least one electrical machine that can serve as an electric motor; the method comprising, a stage in which the fuel consumption gain (G) of the combustion engine is determined in real time by calculating the difference between the consumption in thermal mode (Conso) and the estimated consumption (Conso_{equivalent}) in electric mode, and wherein the consumption gain (G) is determined as a function of one or more operational parameters, of one or more of the elements of the power train.

2. The method according to claim 1, wherein the operational parameter, or one of the operational parameters, taken into account is the respective temperature of one or more of the elements of the power train.

3. The method according to claim 2, wherein the element or the elements of the power train, of which the temperature is taken into account for calculating the losses are the electrical machine(s) and/or the energy storage means.

4. The method according to any of the claim 1, characterized in that gain (G) is expressed in the following manner
G(g/s)=Conso−K[Pmth/η_{elec}]
where
Conso is the consumption of the combustion engine;
Pmth=the power supplied by the combustion engine;
K=a proportionality coefficient defined by a predetermined chart of the combustion engine; and
η_{elec}=the efficiency of the electrical power train, the efficiency being a function of the operational parameter(s) of the power train, by preference the respective temperature of at least one of the elements of the power train.

5. The method according to claim 1, in which the elements of said power train comprise a means for recuperating energy and a means for storing energy, wherein the method comprises a stage where the combustion engine (1) is turned off or on as a function of one or more criteria and as a function of the consumption gain (G), and where a positive consumption gain (G) is a necessary but not sufficient condition for turning off the combustion engine.

6. The method according to claim 5, wherein the method comprises a stage where the combustion engine continues to run even if the gain (G) is positive, and the operating criterion or one of the operating criteria depends on the recuperation level of the electric energy recuperation means and/or the electric energy storage means, and where this criterion prevents the combustion engine from being turned off as long as the electric energy stored in the energy storage means has not reached a predetermined value.

7. The method according to claim 5, wherein the method comprises a stage where the combustion engine continues to run even if the gain (G) is positive, and where the operating criterion, or one of the operating criteria, depending on the temperature of lubricating oil of the combustion engine prevents the combustion engine from being turned off as long as the temperature of the lubrication oil has not reached a predetermined value.

8. The method according to claim 1, wherein at least one motor ventilator group is provided for cooling of the combustion engine, the method comprising a stage where the power and/or the start frequency of the motor ventilator group(s) for cooling of the combustion engine (1) is regulated so that the temperature of the combustion engine will not drop below a predetermined temperature, in particular when the engine is temporarily turned off.

9. A device for managing the implementation of the method according to claim 1, wherein the device comprises a control unit and sensors for at least one operational parameter of the power train, these sensors being positioned on at least one element of the power train, and the operational parameter, or one of the operational parameters, is used for managing the energy in the power train.

10. Hybrid automotive vehicle comprising a control device according to claim 9.

11. The method according to claim 6, wherein the method comprises a stage where the combustion engine continues to run even if the gain (G) is positive, and where the operating criterion, or one of the operating criteria, depending on the temperature of lubricating oil of the combustion engine prevents the combustion engine from being turned off as long as the temperature of the lubrication oil has not reached a predetermined value.
